(19) United States
(12) Patent Application Publication
(10) Pub. No.: US 2026/0264766 A1
(43) Pub. Date: Sep. 10, 2026

(54) DASH PANEL ASSEMBLY

(71) Applicants: Hyundai Motor Company, Seoul (KR); Kia Corporation, Seoul (KR)

(72) Inventor: Sung Min Mun, Hwaseong-si (KR)

(21) Appl. No.: 19/229,898

(22) Filed: Jun. 5, 2025

(30) Foreign Application Priority Data
Mar. 6, 2025 (KR) 10-2025-0028881

(51) Int. Cl. B62D 25/14

(52) U.S. Cl. CPC B62D 25/145

(57) ABSTRACT

Provided is a dash panel assembly that may satisfy the rigidity requirements of a convertible body having a long hood, for example. The dash panel assembly includes a dash panel dividing an engine compartment or motor compartment and an interior space of a vehicle, a cowl panel coupled to an upper portion of the dash panel, and a dash lower member coupled to a lower portion of the dash panel, wherein the dash panel includes an integrally formed reinforcing portion and the reinforcing portion connects the cowl panel and the dash lower member.

### CROSS-REFERENCE TO RELATED APPLICATIONS

This application claims benefit of priority to Korean Patent Application No. 10-2025-0028881 filed on March 6, 2025 in the Korean Intellectual Property Office, the disclosure of which is incorporated herein by reference in its entirety.

### TECHNICAL FIELD

The present disclosure relates to a dash panel assembly that may satisfy the rigidity requirements for a convertible body having a long hood, for example.

### BACKGROUND

An engine compartment or a motor compartment (or a power train electronics (PE) compartment) is arranged in a front body of the vehicle, and the engine compartment or the motor compartment and the interior space of the vehicle are partitioned by a dash panel. A hood is mounted on top of the engine compartment or the motor compartment, and a cowl panel is installed between the hood and a windshield.

The cowl panel installed above the dash panel, together with the dash panel, acts as a partition between the engine compartment or the motor compartment and the interior space and connects the left and right sides of the vehicle to maintain lateral rigidity. The cowl panel may absorb impact energy occurring in the case of a vehicle collision.

For example, a convertible vehicle having a long hood has a relatively long front body and front wheels are relatively close to a front end of the vehicle, as compared to other vehicle types. This causes front seats to move rearward, and a distance between the center of the front wheel and a ball of foot (BOF) increases.

At this time, a distance in a length direction of the vehicle body from a matching point of the dash panel and a front floor complete to a matching point of the dash panel and the cowl panel may increase, so that a bent portion may be inevitably formed in the dash panel, and as a result, there is a problem that the moment due to an upper load and deformation and moment due to a collision load may be excessively applied.

In addition, due to a convertible structure, the number of members or parts directly fastened to the dash panel may increase, and thus, it is required to reinforce the rigidity of the dash panel, thereby increasing the weight and/or cost of the dash panel.

### SUMMARY

An aspect of the present disclosure is to provide a dash panel assembly that may satisfy the rigidity requirements of a convertible body having a long hood, for example.

According to an aspect of the present disclosure, a dash panel assembly includes: a dash panel dividing an engine compartment or motor compartment and an interior space of a vehicle; a cowl panel coupled to an upper portion of the dash panel; and a dash lower member coupled to a lower portion of the dash panel, wherein the dash panel includes an integrally formed reinforcing portion and the reinforcing portion connects the cowl panel and the dash lower member.

The dash panel may include a main dash panel and a sub-dash panel connected to the main dash panel in a width direction of the vehicle, and the main dash panel may cover a central portion of the dash panel in the width direction and a region of the dash panel in the width direction, and the sub-dash panel may cover the other region in the width direction.

The reinforcing portion may be disposed in a central portion of the dash panel in the width direction.

The reinforcing portion may be formed in the shape of a rib with a U-shaped cross-section.

The reinforcing portion may be formed to protrude toward the engine compartment or the motor compartment.

A flange may be formed in an upper end portion of the reinforcing portion for connection with the cowl panel.

The dash panel may include a bent portion formed by bending a portion of the dash panel in an inclined manner so that the dash panel extends toward the interior, and the reinforcing portion may include an inclined surface and a vertical surface formed by bending the dash panel.

The reinforcing portion may further include at least one reinforcing rib formed integrally with the dash panel.

The reinforcing portion may include an inclined surface and a vertical surface, and the reinforcing rib may include at least one outer longitudinal reinforcing rib formed on the inclined surface and at least one outer longitudinal reinforcing rib formed on the vertical surface.

The reinforcing rib may include at least one outer transverse reinforcing rib connected to the reinforcing portion.

The outer longitudinal reinforcing rib and the outer transverse reinforcing rib may be formed to protrude from a surface of the dash panel toward the engine compartment or the motor compartment.

The reinforcing portion may include an inclined surface and a vertical surface, and the reinforcing rib may include at least one inner longitudinal reinforcing rib extending from the inclined surface to the vertical surface and at least one inner transverse reinforcing rib extending across the vertical surface.

The inner longitudinal reinforcing rib and the inner transverse reinforcing rib may be formed to protrude from the surface of the dash panel toward the interior.

The dash panel further may include at least one auxiliary reinforcing rib formed integrally and disposed in a portion other than the reinforcing portion.

The dash panel may include a bent portion formed by bending a portion of the dash panel in an inclined manner and an inflection portion bent in an opposite direction of the bent portion, and the auxiliary reinforcing rib may include an inner auxiliary reinforcing rib disposed at an upper end portion of the dash panel or disposed to correspond to the bent portion and an outer auxiliary reinforcing rib disposed to correspond to the inflection portion.

The inner auxiliary reinforcing rib may be formed to protrude from a surface of the dash panel toward the interior, while extending in a height direction of the dash panel, and the outer auxiliary reinforcing rib may be formed to protrude from a surface of the dash panel toward the engine compartment or the motor compartment, while extending in the height direction of the dash panel.

The dash panel further may include a mounting portion for mounting a component of the vehicle.

The mounting portion may include a first mounting portion disposed on the reinforcing portion and a second mounting portion disposed on the dash panel outside the reinforcing portion.

The first mounting portion and the second mounting portion may be formed to extend in a cantilever shape, and a through-hole may be formed in the first mounting portion and the second mounting portion.

A strut bar may be coupled to the first mounting portion, and an integrated charging system and a battery module may be coupled to the second mounting portion.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a perspective view illustrating a dash panel assembly according to an embodiment of the present disclosure;

FIG. 2 is a cross-sectional view taken along line A-A’ of FIG. 1;

FIG. 3 is an exploded perspective view of FIG. 1;

FIG. 4 is a diagram illustrating the transmission of force in a tower bar and a strut bar;

FIG. 5 is a perspective view illustrating a main dash panel;

FIG. 6 is a cross-sectional view taken along line B-B’ of FIG. 5;

FIG. 7 is a front view of the main dash panel viewed from the interior side;

FIG. 8 is a cross-sectional view taken along line C-C’ of FIGS. 5 and 7; and

FIG. 9 is a perspective view of a dash panel assembly applied to a vehicle viewed from a motor compartment side according to an embodiment of the present disclosure.

### DETAILED DESCRIPTION OF ILLUSTRATIVE EMBODIMENTS

Hereinafter, the present disclosure is described in detail through drawings. When adding reference numerals to components in each drawing, it should be noted that identical components are given the same reference numerals as much as possible although they are shown in different drawings. In addition, the terms used in relation to direction are defined based on a vehicle body, i.e., an installation target.

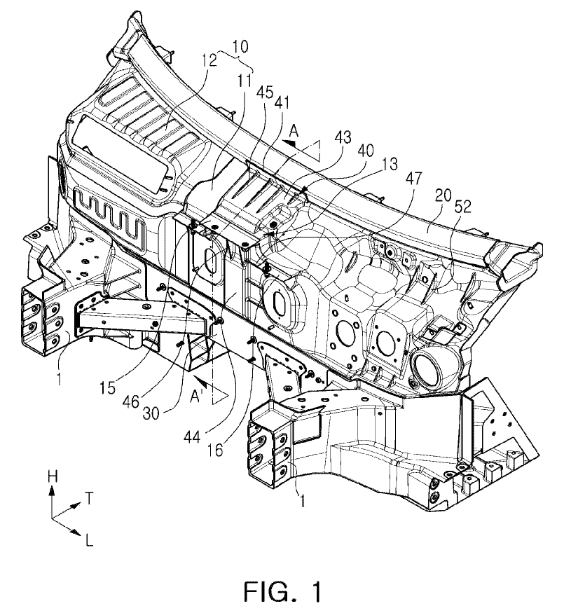

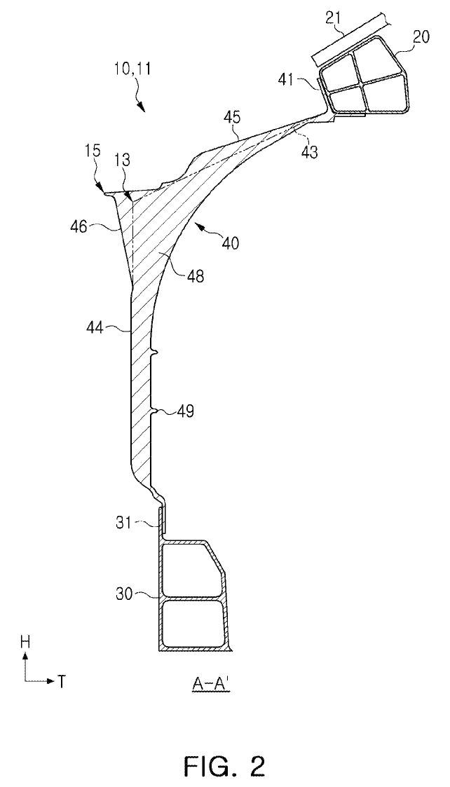

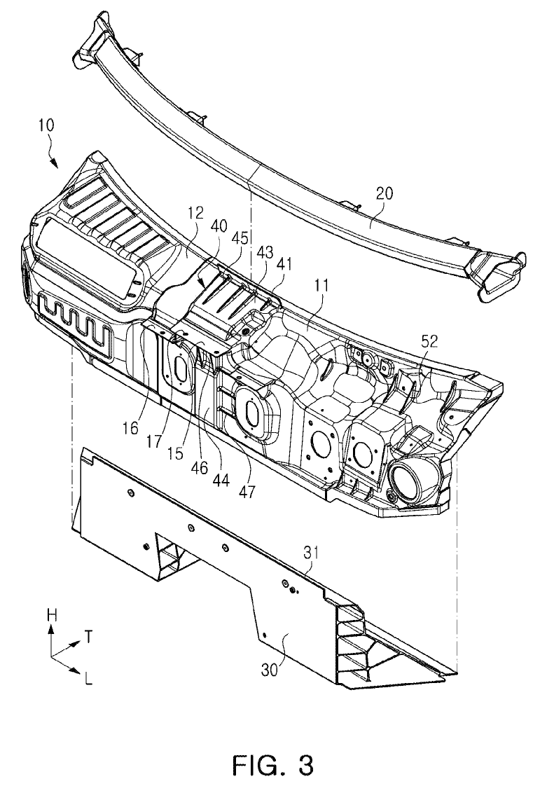

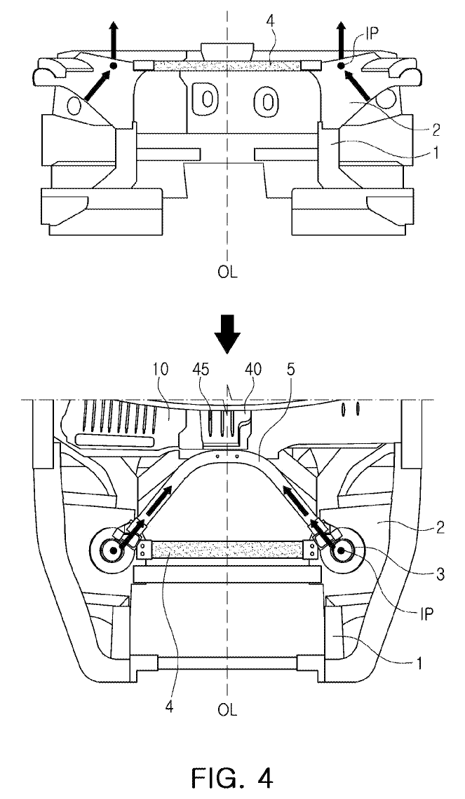

FIG. 1 is a perspective view illustrating a dash panel assembly according to an embodiment of the present disclosure, and FIG. 2 is a cross-sectional view taken along line A-A’ of FIG. 1. FIG. 3 is an exploded perspective view of FIG. 1. Here, line A-A’ coincides with a widthwise center line (OL; see FIG. 4) of a vehicle.

As shown in these drawings, a dash panel assembly according to an embodiment of the present disclosure may include a dash panel 10, a cowl panel 20, and a dash lower member 30.

First, the dash panel assembly according to an embodiment of the present disclosure may be applied to a vehicle. Such vehicles include, for example, an electric vehicle generating driving power with a motor or a plug-in hybrid vehicle generating driving power with at least one of an engine or a motor.

However, the vehicles to which the dash panel assembly according to an embodiment of the present disclosure is applicable are not limited to the aforementioned examples, and it is to be noted that the dash panel assembly according to an embodiment of the present disclosure may also be applied to an internal combustion engine vehicle generating driving power with only an engine.

As shown in FIG. 1, side members 1 are installed on both lower sides of an engine compartment or motor compartment, and a dash panel 10 for the boundary between the engine compartment or motor compartment and the interior space may be installed on the rear side of the engine compartment or motor compartment.

An apron 2 (see FIG. 4) may be installed on top of the side member 1, and a shock absorber housing 3 may be fixed to the apron.

The dash panel 10 may extend in a width direction (an L direction) and height direction (the H direction) of the vehicle to partition the engine compartment or motor compartment and the interior space. A cowl panel 20 may be installed above the dash panel, and a dash lower member 30 may be fixedly installed below the dash panel.

Optionally, the dash panel 10 may include a main dash panel 11 and a sub-dash panel 12. The main dash panel and the sub-dash panel may be connected in the width direction (the L direction) of the vehicle.

For example, the main dash panel 11 may cover the center of the dash panel 10 in the width direction (the L direction) and a region on the driver’s side, and the sub-dash panel 12 may cover a region on the passenger’s side. The main dash panel and the sub-dash panel may be fixedly connected to each other by welding or screws (e.g., a flow drilling screw (FDS)).

For example, as described above, in a convertible vehicle with a long hood, a front body is relatively long compared to other vehicle types and front seats move rearward, and thus, a vertical dash panel may not be simply matched with a cowl panel.

To solve this, the dash panel 10 may include a bent portion 13 formed by slantingly bending an upper portion of the dash panel so that the dash panel extends toward the interior. Accordingly, the upper end of the dash panel may be matched with the cowl panel 20.

The cowl panel 20 may be formed as a closed cross-section, for example, but is not necessarily limited thereto, and may be formed as an open cross-section. The cowl panel may be connected to the dash panel 10 in the width direction (the L direction) of the vehicle by welding or screws (e.g., an FDS).

This cowl panel 20, together with the dash panel 10, may act as a partition between the engine compartment or motor compartment and the interior space, connect the left and right sides of the vehicle to maintain lateral rigidity, and absorb impact energy occurring at the time of vehicle collision.

Here, reference numeral 21 of FIG. 2 denotes a windshield.

Both end portions of the dash lower member 30 may each be fixed and connected to the side member 1. The dash lower member may be formed to have a closed cross-section to ensure sufficient rigidity, for example, but the cross-sectional shape is not necessarily limited thereto.

In addition, the dash lower member 30 may include a flange 31 formed for connection with the dash panel 10. The dash lower member may be connected to the dash panel in the width direction (the L direction) of the vehicle via the flange 31 by welding or screws (e.g., an FDS).

In this manner, by installing the dash lower member 30 below the dash panel 10, a load transferred from the cowl panel 20 to the dash panel may be effectively distributed and transferred to the side member 1 of the vehicle body through the dash lower member.

FIG. 4 is a diagram illustrating the transfer of force from a tower bar and a strut bar.

As described above, in the case of a convertible vehicle with a long hood, the distance from the matching point of the dash panel and the front floor complete to the matching point of the dash panel and the cowl panel in the length direction of the vehicle body may increase, so that the bent portion 13 may be inevitably formed in the dash panel, and as a result, there is a problem that the moment due to an upper load and deformation and moment due to a collision load may be excessively applied.

In addition, due to the convertible structure, the number of members or parts directly fastened to the dash panel 10 may increase, and thus, it is necessary to reinforce the rigidity of the dash panel.

Furthermore, when a double wishbone suspension is applied to the front wheels of a convertible vehicle with a long hood, the shock absorber housing 3 may be tilted toward the vehicle’s width-direction centerline OL, which means that the load through the suspension is divided into the vehicle’s width-direction (the L direction) and the vehicle’s height-direction (the H direction) through an input point IP.

The shock absorber housings 3 on both sides may receive a load transferred in the width-direction, and the tower bar 4 may be installed to reinforce this as shown in FIG. 4. However, when a reverse load is applied to the two input points IP, the tower bar does not perform its function.

Accordingly, a strut bar 5 may be additionally installed to reinforce the load input in the width-direction. The strut bar has to preferably have a restraining point located as far away from the input point IP as possible to withstand the width-direction load, and to this end, the dash panel 10 connected to restrain the strut bar has to have high rigidity.

In addition, noise may be transferred through the movement of the windshield 21. Specifically, the glass of a windshield vibrates up and down and/or forward and backward to create air waves, and noise caused by this movement may be transferred to people inside the vehicle.

In order to restrain the windshield 21, it is necessary to increase the rigidity of the matched vehicle body, and accordingly, a structure is required to connect the cowl panel 20 to which the windshield is matched, the dash panel 10, and the dash lower member 30.

In order to solve such requirements or problems, the dash panel 10 of the dash panel assembly according to an embodiment of the present disclosure may include a reinforcing portion 40 elongated approximately in the height direction in the center of the width direction (the L direction) of the dash panel to connect the cowl panel 20 installed above the dash panel and the dash lower member 30 installed below the dash panel.

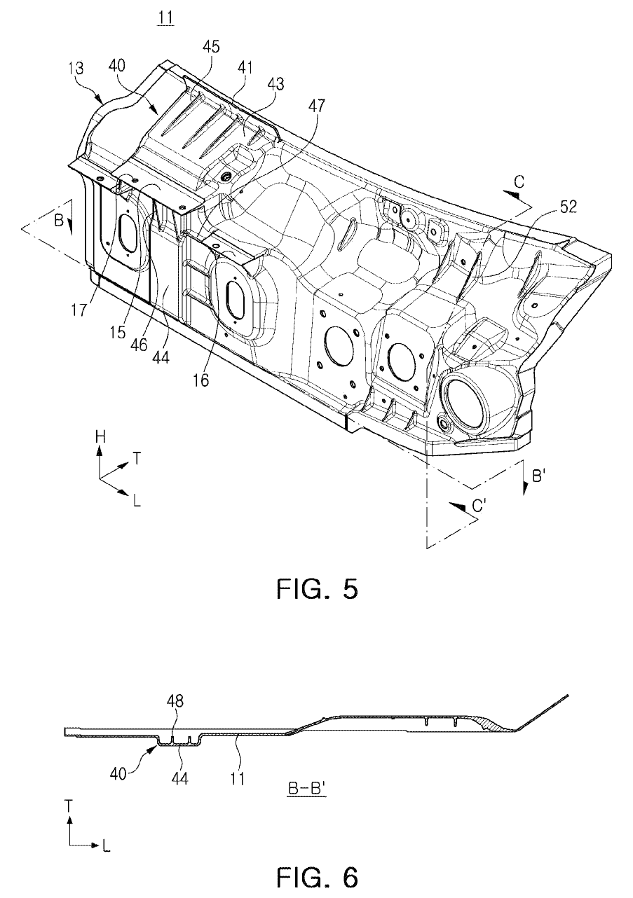

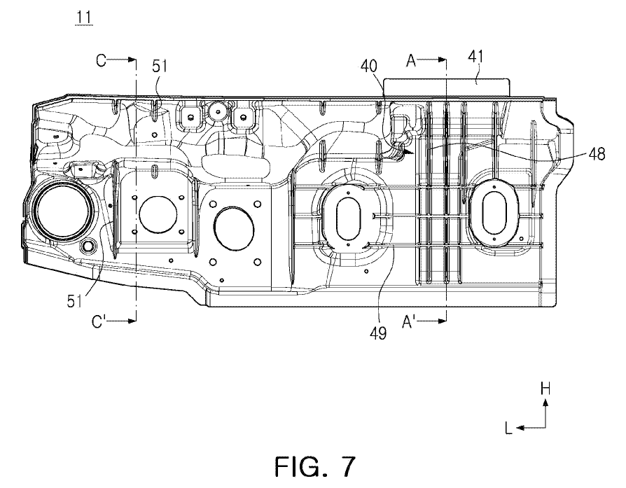

FIG. 5 is a perspective view illustrating the main dash panel, and FIG. 6 is a cross-sectional view taken along the line B-B’ of FIG. 5. In addition, FIG. 7 is a front view of the main dash panel viewed from the interior.

The reinforcing portion 40 may be formed in a rib shape having a roughly bent U-shaped cross-section. The reinforcing portion may be formed to protrude toward the engine compartment or motor compartment and may be formed to be concave toward the interior.

A flange 41 may be formed at an upper end portion of the reinforcing portion 40 for connection to the cowl panel 20, and the upper end portion of the reinforcing portion may be connected to the cowl panel 20 by welding or a screw (e.g., an FDS) via the flange.

Meanwhile, a lower end of the reinforcing portion 40 is integrally converged with a lower edge of the dash panel 10, i.e., the main dash panel 11, and the lower edge of the dash panel may be connected to the dash lower member 30 by welding or screws (e.g., an FDS) via the flange 31 of the dash lower member 30.

The reinforcing portion 40 may include an inclined surface 43 formed by bending the dash panel 10 and a vertical surface 44 extending from the inclined surface. In addition, the reinforcing portion may further include at least one reinforcing rib 45 to 49 to increase the bending rigidity in the height direction (the H direction) and/or width direction (the L direction).

For example, on the surface of the reinforcing portion 40 adjacent to the engine compartment or motor compartment, at least one outer longitudinal reinforcing rib 45 may be formed on an inclined surface 43, and at least one outer longitudinal reinforcing rib 46 may be formed on the vertical surface. In addition, at least one outer transverse reinforcing rib 47 connected laterally (in the width direction) to the reinforcing portion may be formed on the surface of the main dash panel 11.

On the surface of the dash panel adjacent to the engine compartment or motor compartment, the outer longitudinal reinforcing rib 45 of the inclined surface 43, the outer longitudinal reinforcing rib 46 of the vertical surface 44, and the outer transverse reinforcing rib 47 connected to the reinforcing portion 40 may be formed to protrude from the surface of the reinforcing portion and the surface of the main dash panel 11 toward the engine compartment or motor compartment, but are not necessarily limited thereto.

In addition, on the surface of the reinforcing portion 40 adjacent to the interior, at least one inner longitudinal reinforcing rib 48 extending from the inclined surface 43 to the vertical surface 44 may be formed, and at least one inner transverse reinforcing rib 49 extending across the vertical surface to the main dash panels 11 on both sides may be formed.

On the surface of the dash panel adjacent to the interior, the inner longitudinal reinforcing rib 48 and the inner transverse reinforcing rib 49 may be formed to protrude from the surface of the reinforcing portion 40 and the surface of the main dash panel 11 toward the interior, but are not necessarily limited thereto.

In this manner, the dash panel 10 of the dash panel assembly according to an embodiment of the present disclosure has a rib-shaped reinforcing portion 50 in the bent portion 13 and a load input portion (e.g., a connection point of the strut bar) and at least one reinforcing rib 45 to 49 in the reinforcing portion itself, thereby obtaining the advantage of reinforcing the bending rigidity of the dash panel and reducing the amount of deformation of the dash panel at the same time.

In addition, the dash panel 10 of the dash panel assembly according to an embodiment of the present disclosure may be integrally formed with the reinforcing portion 40 and at least one reinforcing rib 45 to 49 accompanying the reinforcing portion 40 by utilizing the characteristics of a casting method advantageous in shape implementation, thereby providing a vehicle body structure that may respond to the layout of a convertible vehicle with a long hood, for example, without increasing weight and/or cost.

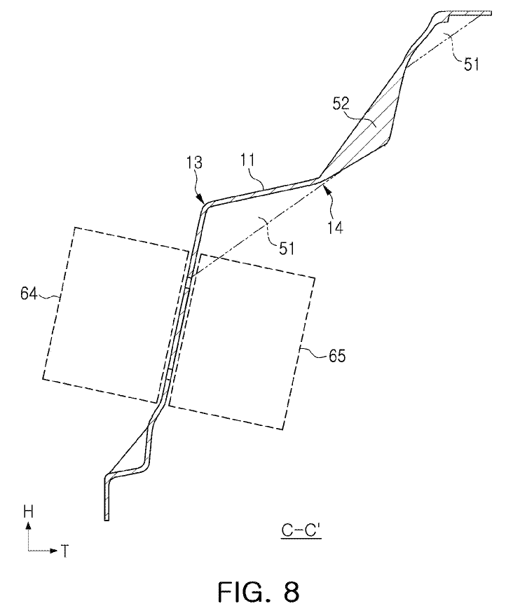

FIG. 8 is a cross-sectional view taken along line C-C’ of FIGS. 5 and 7.

Additionally, at least one auxiliary reinforcing ribs 51 and 52 may be formed in a portion other than the reinforcing portion 40 in the dash panel 10, i.e., the main dash panel 11.

For example, an inner auxiliary reinforcing rib 51 may be disposed to be adjacent to an upper end portion of the dash panel 10, i.e., the main dash panel 11, to correspond to the bent portion 13. The inner auxiliary reinforcing rib may be formed to protrude from the surface of the dash panel toward the interior, while extending approximately in the height direction (the H direction).

In addition, an outer auxiliary reinforcing ribs 52 may be arranged to correspond to an inflection portion 14 of the dash panel 10, i.e., the main dash panel 11. Here, the inflection portion is formed by bending a portion in the opposite direction of the bent portion between the bent portion 13 and the upper end portion. The outer auxiliary reinforcing rib may be formed to protrude from the surface of the dash panel toward the engine compartment or motor compartment, while extending approximately in the height direction (the H direction).

These auxiliary reinforcing ribs, i.e., the inner auxiliary reinforcing rib 51 and the outer auxiliary reinforcing ribs 52 disposed in a portion other than the reinforcing portion, may also be formed integrally with at least the main dash panel 11 of the dash panel 10 by utilizing the characteristics of a casting method advantageous in shape implementation.

In this manner, the dash panel 10 of the dash panel assembly according to an embodiment of the present disclosure has the advantage of reinforcing the bending rigidity of the dash panel and reducing the amount of deformation of the dash panel by additionally providing at least one auxiliary reinforcing rib 51 and 52 in addition to the reinforcing portion 40.

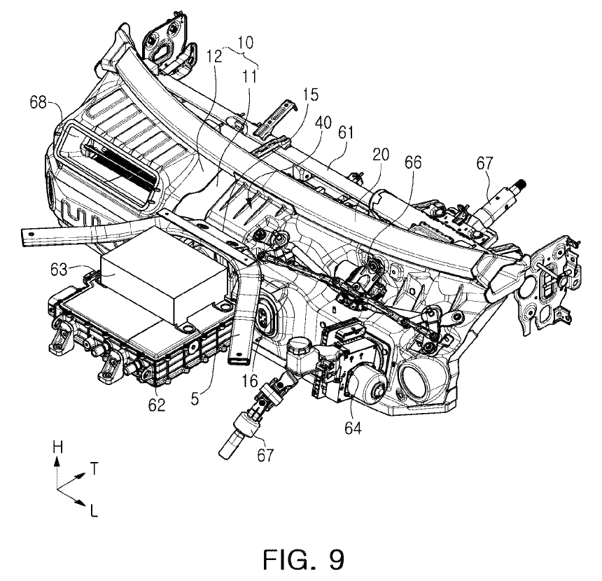

FIG. 9 is a perspective view of the dash panel assembly applied to a vehicle according to an embodiment of the present disclosure, viewed from the motor compartment side.

As illustrated in FIG. 9, the dash panel 10 of the dash panel assembly according to an embodiment of the present disclosure may be combined with a cowl crossbar 61, the strut bar 5, an integrated charging system (or an integrated charging control unit (ICCU)) 62, a battery module 63, an integrated electric braking system (or an integrated electric brake (IEB)) 64, a brake pedal 65, a wiper device 66, a steering device 67, an air-conditioning device 68, and the like.

For example, the integrated charging system 62 and the battery module 63 are components weighing about 20 kg, which concentrate stress at a joint portion with the dash panel 10. In addition, the strut bar 5 is coupled at an adjacent position, so that the load is transferred through the shock absorber housing 3.

The dash panel 10 of the dash panel assembly according to an embodiment of the present disclosure may further include a mounting portion for smoothly and firmly mounting these components. In addition, the mounting portion may include a first mounting portion 15 and a second mounting portion 16.

The first mounting portion 15 may be formed on the bent portion 13 in the reinforcing portion 40 so that the strut bar 5 may be coupled. The first mounting portion may be formed to extend in a cantilever shape from the surface of the reinforcing portion adjacent to the engine compartment or motor compartment toward the inside of the engine compartment or motor compartment. In addition, the first mounting portion may be formed with a through-hole 17 for bolting the strut bar, for example.

The second mounting portion 16 may be formed as a pair on the dash panel 10 outside the reinforcing portion 40 so that, for example, the integrated charging system 62 and the battery module 63 may be coupled thereto. The second mounting portion may be formed to extend in a cantilever shape from the surface of the dash panel adjacent to the engine compartment or motor compartment toward the inside of the engine compartment or motor compartment. In addition, the second mounting portion may be formed with a through-hole 17 for bolting, for example, an integrated charging system and a battery module.

The first mounting portion 15 and second mounting portion 16 provide rigidity capable of withstanding an applied load and also provide a structure allowing components to be directly coupled to the dash panel 10 instead of an assembly bracket due to disadvantageous joining conditions.

In addition, the integrated electric braking system 64 may be coupled to the surface of the dash panel 10 adjacent to the engine compartment or motor compartment side, away from the reinforcing portion 40, while the brake pedal (65; see FIG. 8) may be coupled to the surface of the dash panel adjacent to the interior, away from the reinforcing portion.

At a portion of the dash panel 10, to which the integrated electric braking system 64 and the brake pedal 65 are coupled, the bending rigidity of the dash panel may be reinforced by at least one auxiliary reinforcing rib, that is, an inner auxiliary reinforcing rib 51 located in a portion other than the reinforcing portion 40, thereby reducing the amount of the deformation of the dash panel, and thus obtaining the advantage of reducing human injury due to being pushed by a collision in an accident situation.

In addition, even though the cowl panel 20 is moved rearward and the dash panel 10 has a structurally disadvantageous shape for the cowl crossbar 61 and the wiper device 66 to be coupled, a structure in which the rigidity of the dash panel is reinforced by at least one auxiliary reinforcing rib, that is, the outer auxiliary reinforcing rib 52 arranged to correspond to the inflection portion 14 of the dash panel, while allowing the parts to be directly combined, may be provided.

As described above, according to the dash panel assembly according to an embodiment of the present disclosure, the rib-shaped reinforcing portion is added to a portion of the dash panel requiring rigidity by utilizing the characteristics of the casting method advantageous in shape implementation, and the reinforcing portion connects the closed cross-sections of the cowl panel and the dash lower member, thereby increasing the bending rigidity of the dash panel, and implementing a vehicle body structure that may respond to the layout of a convertible vehicle with a long hood, for example.

The above description is merely illustrative of the technical idea of the present disclosure, and various modifications and changes may be made by those skilled in the art without departing from the essential characteristics of the present disclosure.

Accordingly, the embodiments disclosed in the present disclosure and the accompanying drawings are not intended to limit the technical idea of the present disclosure but to describe the present disclosure, and the scope of the technical idea of the present disclosure is not limited by the embodiments and the accompanying drawings. The protection scope of the present disclosure should be interpreted by the following claims, and all technical ideas within the equivalent scope should be interpreted as being included in the scope of the present disclosure.

What is claimed is:

1. A dash panel assembly comprising:
a dash panel dividing an engine compartment or a motor compartment and an interior space of a vehicle;
a cowl panel coupled to an upper portion of the dash panel; and
a dash lower member coupled to a lower portion of the dash panel,
wherein:
the dash panel includes an integrally formed reinforcing portion, and
the reinforcing portion connects the cowl panel and the dash lower member.

2. The dash panel assembly of claim 1, wherein:
the dash panel further includes a main dash panel and a sub-dash panel connected to the main dash panel in a width direction of the vehicle,
the main dash panel covers a central portion of the dash panel in the width direction and a region of the dash panel in the width direction, and
the sub-dash panel covers another region in the width direction.

3. The dash panel assembly of claim 1, wherein the reinforcing portion is disposed in a central portion of the dash panel in a width direction.

4. The dash panel assembly of claim 1, wherein the reinforcing portion is formed in a shape of a rib with a U-shaped cross-section.

5. The dash panel assembly of claim 4, wherein the reinforcing portion is formed to protrude toward the engine compartment or the motor compartment.

6. The dash panel assembly of claim 4, wherein a flange is formed in an upper end portion of the reinforcing portion for connection with the cowl panel.

7. The dash panel assembly of claim 1, wherein:
the dash panel includes a bent portion formed by bending a portion of the dash panel in an inclined manner so that the dash panel extends toward the interior space, and
the reinforcing portion includes an inclined surface and a vertical surface formed by bending the dash panel.

8. The dash panel assembly of claim 1, wherein the reinforcing portion further includes at least one reinforcing rib formed integrally with the dash panel.

9. The dash panel assembly of claim 8, wherein:
the reinforcing portion includes an inclined surface and a vertical surface, and
the at least one reinforcing rib includes at least one first outer longitudinal reinforcing rib formed on the inclined surface and at least one second outer longitudinal reinforcing rib formed on the vertical surface.

10. The dash panel assembly of claim 9, wherein the at least one reinforcing rib further includes at least one outer transverse reinforcing rib connected to the reinforcing portion.

11. The dash panel assembly of claim 10, wherein the outer longitudinal reinforcing ribs and the at least one outer transverse reinforcing rib are formed to protrude from a surface of the dash panel toward the engine compartment or the motor compartment.

12. The dash panel assembly of claim 8, wherein:
the reinforcing portion includes an inclined surface and a vertical surface, and
the reinforcing rib includes at least one inner longitudinal reinforcing rib extending from the inclined surface to the vertical surface and at least one inner transverse reinforcing rib extending across the vertical surface.

13. The dash panel assembly of claim 12, wherein the inner longitudinal reinforcing rib and the inner transverse reinforcing rib are formed to protrude from a surface of the dash panel toward the interior space.

14. The dash panel assembly of claim 1, wherein the dash panel further includes at least one auxiliary reinforcing rib formed integrally and disposed in a portion other than the reinforcing portion.

15. The dash panel assembly of claim 14, wherein:
the dash panel includes a bent portion formed by bending a portion of the dash panel in an inclined manner and an inflection portion bent in an opposite direction of the bent portion, and
the auxiliary reinforcing rib includes an inner auxiliary reinforcing rib disposed at an upper end portion of the dash panel or disposed to correspond to the bent portion and an outer auxiliary reinforcing rib disposed to correspond to the inflection portion.

16. The dash panel assembly of claim 15, wherein:
the inner auxiliary reinforcing rib is formed to protrude from a first surface of the dash panel toward the interior space, while extending in a height direction of the dash panel, and
the outer auxiliary reinforcing rib is formed to protrude from a second surface of the dash panel toward the engine compartment or the motor compartment, while extending in the height direction of the dash panel.

17. The dash panel assembly of claim 1, wherein the dash panel further includes a mounting portion for mounting a component of the vehicle.

18. The dash panel assembly of claim 17, wherein the mounting portion includes a first mounting portion disposed on the reinforcing portion and a second mounting portion disposed on the dash panel outside the reinforcing portion.

19. The dash panel assembly of claim 18, wherein:
the first mounting portion and the second mounting portion are formed to extend in a cantilever shape, and
a through-hole is formed in the first mounting portion and the second mounting portion.

20. The dash panel assembly of claim 18, wherein:
a strut bar is coupled to the first mounting portion, and
an integrated charging system and a battery module are coupled to the second mounting portion.
